(19) United States
(12) Patent Application Publication
(10) Pub. No.: US 2024/0202771 A1
(43) Pub. Date: Jun. 20, 2024

(54) OFFLINE SIMULATION OF MULTIPLE EXPERIMENTS WITH VARIANT ADJUSTMENTS

(71) Applicant: Maplebear Inc. (dba Instacart), San Francisco, CA (US)

(72) Inventors: Ruhan Zhang, Seattle, WA (US); Jeffrey Moulton, San Francisco, CA (US); Nicholas George Gordenier, Georgetown, CO (US)

(21) Appl. No.: 18/084,938

(22) Filed: Dec. 20, 2022

(51) Int. Cl. G06Q 30/0241; G06Q 30/0242

(52) U.S. Cl. CPC G06Q 30/0249; G06Q 30/0242; G06Q 30/0277

(57) ABSTRACT

An online concierge system may conduct experiments in presentation of prioritized items for content campaigns with offline simulations. The offline simulation may use a joint budget for the content campaign used by several experimental variations that affect prioritized content presentation. To correct for distortions that may occur from differing rates of budget use in the variations when the budget is reached before a total period for the experiment, the budget use of each variation is compared to a “fair value” to determine an adjustment to the metrics determined in the experiment. Variants that exceed the fair value may have their metrics capping to the portion allocable to a budget use that does not exceed the fair value, while variants that use less than the fair value may have the metrics extrapolated to account for the additional budget that would be available with a fair value budget.

### BACKGROUND

This disclosure relates generally to computer hardware and software for experimental simulation, and more specifically to offline simulation of multiple A/B experiments performed on content campaigns with adjustments for proportions of a content campaign used by each variant.

An online concierge system may comprise an online computer system by which users can order items to be provided to them. Some online concierge systems use sophisticated algorithms and machine learning models to determine which items to present to a user who is selecting items to order. Over time, these algorithms and models may be changed when a new feature is added to the online concierge system. For example, a new feature may be a new algorithm or model to be used by the online concierge system to select items to present to users, or a new feature may be one or more new parameters for existing algorithms or models. New features may also include different user interface flows or elements that present items with different frequencies and in different ways. With sophisticated systems like online concierge systems, it can be difficult to predict how these new features will impact user interactions with items. Thus, an online concierge system may test the performance of the new feature by using it to present items to a test set of users.

The online concierge system may also select items based on additional prioritization schemes that may include items that are selected based on values associated with each item in an associated content campaign. When an item is presented based on the prioritization, the presentation and/or selection of the item by the user may then use a portion of an associated presentation budget for the content campaign associated with the item. An item may be associated with a content campaign based on available item quantity, frequency of user purchases, item profit margin, season, sponsorship by external partners, etc. The content campaign and its presentation budget may thus represent the total extent to which the particular item is to be prioritized; similarly, the portion (e.g., a particular amount or value) of the presentation budget used to compete with other content campaigns represents the extent to which it should be prioritized relative to other items for prioritization.

When new features are considered for the online concierge system, these features may affect the presentation of prioritized items, for example, by modifying the frequency that prioritized items are presented or the way that the presentation budget is used in presenting prioritized items. The way in which new features may affect the prioritized items may be difficult to directly determine, and designers may wish to evaluate various metrics, such as the expected total prioritization capacity, as affected by various new features. As one way of evaluating the effect of modifying features, the online concierge system may perform experiments in which different features are evaluated as different variants in an experiment. The variants typically include at least a control variant indicating the current way the system provides features, and a test variant with a modification (e.g., of the new or modified feature). This may be intended to provide an A/B comparison of the effects of the feature. However, in many instances, operators of the online concierge system may wish to evaluate a large number of different experiments simultaneously. Performing these experiments on live users (e.g., with live content campaigns and presentation budgets) may mean that the presentation budget is split across the many different experiments, limiting the presentation budget actually available for (or used by) each experimental variant or creating unacceptably small sample sizes.

In addition, the presentation of prioritized items in each variant may each draw from the same presentation budget, such that the variants may exhaust the budget early and unevenly use the presentation budget within a time period for the experiment. When the total available presentation budget for an item may be constant over the experimental period, it may be misleading to directly compare metrics between variants. The uneven use of budget may appear beneficial to the variant that has a higher rate of budget use, but an earlier-exhausted budget may not mean that further presentation budget is available for that item or that the variant effectively used that budget. When evaluating the effect of these metrics (along with other metrics unrelated to item prioritization) for features, these problems may make it difficult to correctly evaluate experiments with respect to item prioritization.

### SUMMARY

Experimental results may be corrected for bias in budget usage with an offline “replay” as a simulation using online experimental data (which may use a joint budget and be relatively small) or historical data about content campaigns, enabling many experiments to be performed offline by simulating the experimental results on many content campaigns and while correcting the different presentation budget usage. Many experiments may thus be evaluated with respect to many content campaigns without further affecting the actual presentation budgets, enabling budget usage correction and adequate sample sizes in the simulation of each experiment and with respect to many content campaigns. For each experiment, individual content campaigns may be evaluated with respect to the presentation budget available for that campaign.

The experiment simulates the presentation of the content campaign with each presentation variant of the experiment across an experimental period until the presentation budget is reached and generates a set of campaign metrics for the content campaign at each of the experimental variants. The simulation may be a “replay” of an online experiment performed with one or more presentation variants with a set of campaigns (e.g., using a joint budget) or as a simulation of the presentation variants' behavior based on estimated/historical data. To account for the uneven spending rate of the variations, the actual portion of the budget used by a presentation variant is compared to a fair value or “fair share” (e.g., an even or proportional split) of the campaign budget and/or proportional to the traffic of each presentation variant, and the metrics for a particular variant are adjusted to account for the extent to which the budget portion used by the variant exceeded or fell short of the fair value. Adjusting the metrics to correct for the uneven spending rate may correct for distortions in metrics that may appear from simulating the content presentation. The adjusted metrics for each campaign may then be combined to determine metrics for the overall experiment. The results may also be evaluated with various statistical methods to determine a confidence interval or other statistical metrics for the experiment (e.g., for each variant) based on the adjusted metrics that were simulated for the constituent campaigns. In one embodiment, the confidence interval is determined based on a jackknife resampling.

In addition, in some embodiments the adjusted metrics may be adjusted based on additional data from online experiments. In some circumstances, the simulated experiments may evaluate per-campaign metrics and account for the joint use of a budget by the experimental variants. Online experiments may be performed to determine further adjustments to account for campaign-campaign effects and for separation of campaign budgets to the experimental variants (rather than the joint use of a campaign's presentation budget). As such, one or more experiments may be performed online with campaign budgets to determine metrics for the experiment when the variants are presented to users in real-time. This may also permit evaluation of campaign-campaign interactions during live content presentation. The online experiments may be performed with each variant simultaneously using a joint budget, or with campaign budgets split between the variants during the experiment. The online experiments may be performed to determine corrections to apply to the offline experiments, and in some embodiments are performed for one set of experiments and used to determine online adjustments that may be applied to other experiments. That is, the online adjustments may be used to determine factors to adjust for campaign-campaign and/or split budget experiments in live environments relative to the simulated experiment and apply the factors to other experiments without requiring online testing of every experiment to be evaluated, enabling a large number of features to be evaluated with different experiments without spreading live budgets to each of the experiments and diluting sample sizes or spreading presentation budgets too thin across the various experiments.

### BRIEF DESCRIPTION OF THE DRAWINGS

FIG. 1 is a block diagram of a system environment in which an online system, such as an online concierge system, operates, according to one or more embodiments.

FIG. 2 illustrates an environment of an online platform, such as a shopping concierge system, according to one or more embodiments.

FIG. 3 is a diagram of an online concierge system, according to one or more embodiments.

FIG. 4A is a diagram of a customer mobile application (CMA), according to one or more embodiments.

FIG. 4B is a diagram of a shopper mobile application (SMA), according to one or more embodiments.

FIGS. 5A-B illustrate simulation of experimental variants for a content campaign with a fairness adjustment, according to one or more embodiments.

FIG. 6 is a flowchart of a method for simulating experiments with content campaigns, according to one or more embodiments.

The figures depict embodiments of the present disclosure for purposes of illustration only. Alternative embodiments of the structures and methods illustrated herein may be employed without departing from the principles, or benefits touted, of the disclosure described herein.

### DETAILED DESCRIPTION

### System Architecture

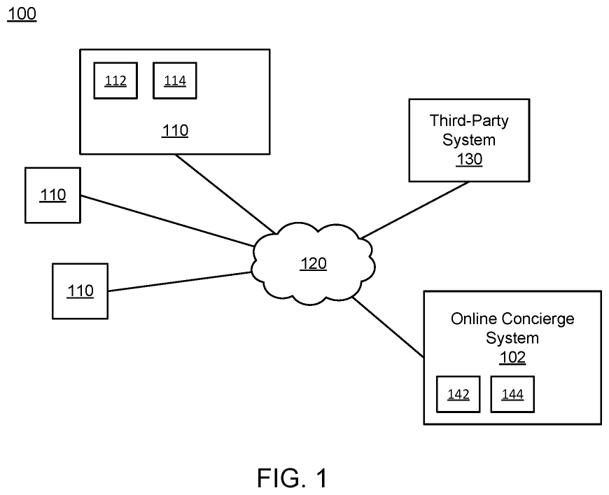

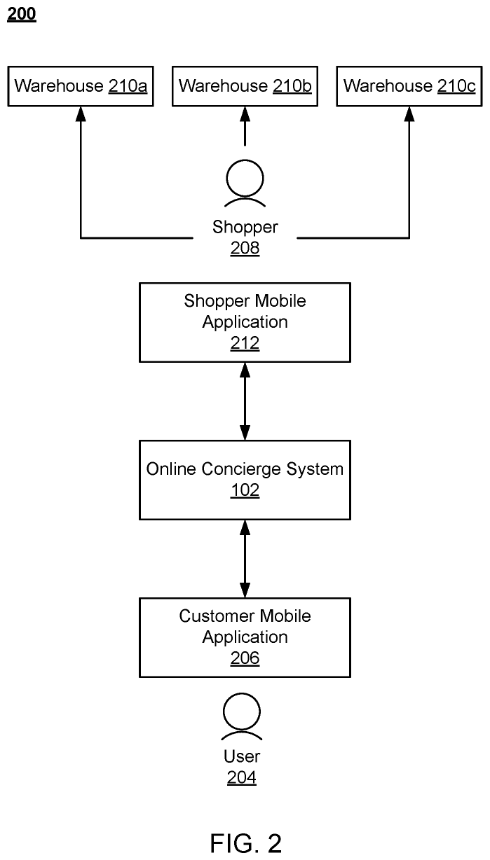

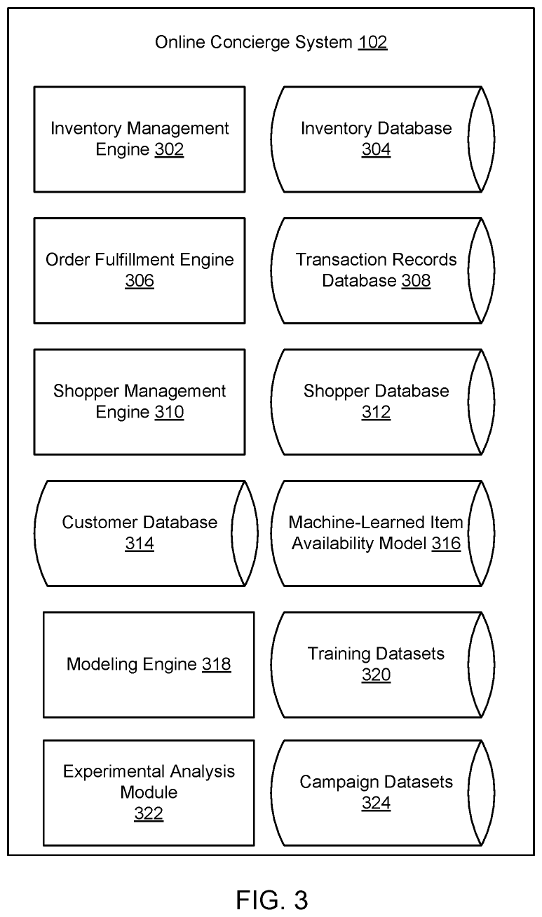

FIG. 1 is a block diagram of a system environment 100 in which an online system, such as an online concierge system 102 as further described below in conjunction with FIGS. 2 and 3, operates, according to one or more embodiments. The system environment 100 shown by FIG. 1 comprises one or more client devices 110, a network 120, one or more third-party systems 130, and the online concierge system 102. In alternative configurations, different and/or additional components may be included in the system environment 100. Additionally, in other embodiments, the online concierge system 102 may be replaced by an online system configured to retrieve content for display to users and to transmit the content to one or more client devices 110 for display.

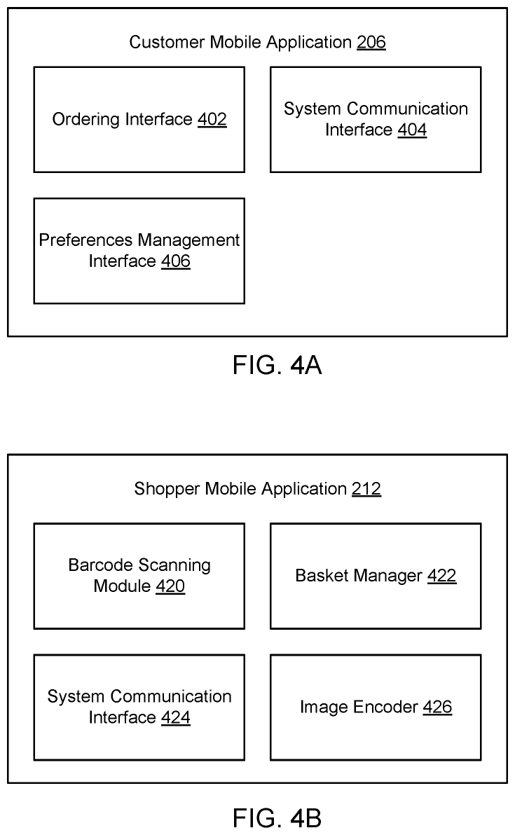

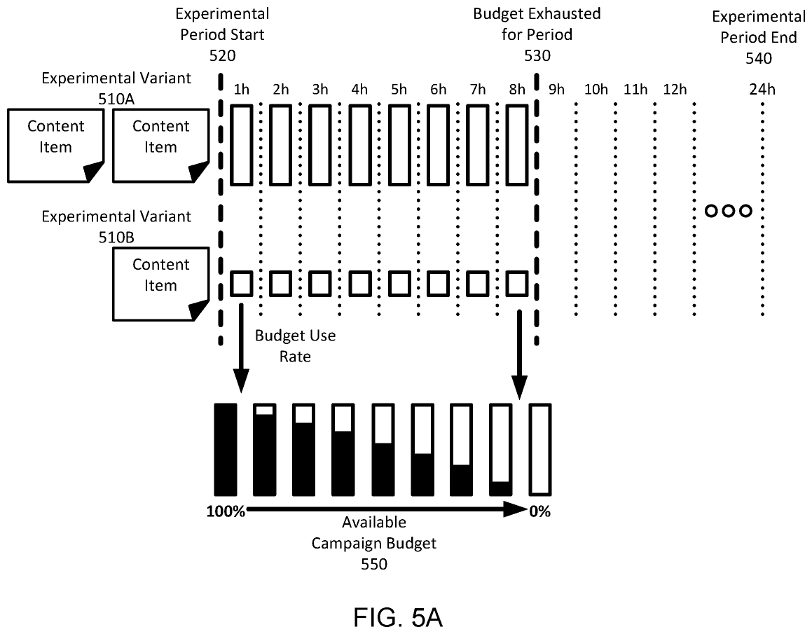

The client devices 110 are one or more computing devices capable of receiving user input as well as transmitting and/or receiving data via the network 120. In one embodiment, a client device 110 is a computer system, such as a desktop or a laptop computer. Alternatively, a client device 110 may be a device having computer functionality, such as a personal digital assistant (PDA), a mobile telephone, a smartphone, or another suitable device. A client device 110 is configured to communicate via the network 120. In one embodiment, a client device 110 executes an application allowing a user of the client device 110 to interact with the online concierge system 102. For example, the client device 110 executes a customer mobile application 206 or a shopper mobile application 212, as further described below in conjunction with FIGS. 4A and 4B, respectively, to enable interaction between the client device 110 and the online concierge system 102. As another example, a client device 110 executes a browser application to enable interaction between the client device 110 and the online concierge system 102 via the network 120. In another embodiment, a client device 110 interacts with the online concierge system 102 through an application programming interface (API) running on a native operating system of the client device 110, such as IOS® or ANDROID™.

A client device 110 includes one or more processors 112 configured to control operation of the client device 110 by performing functions. In various embodiments, a client device 110 includes a memory 114 comprising a non-transitory storage medium on which instructions are encoded. The memory 114 may have instructions encoded thereon that, when executed by the processor 112, cause the processor to perform functions to execute the customer mobile application 206 or the shopper mobile application 212 to provide the functions further described above in conjunction with FIGS. 4A and 4B, respectively.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third-party systems 130 may be coupled to the network 120 for communicating with the online concierge system 102 or with the one or more client devices 110. In one embodiment, a third-party system 130 is an application provider communicating information describing applications for execution by a client device 110 or communicating data to client devices 110 for use by an application executing on the client device. In other embodiments, a third-party system 130 provides content or other information for presentation via a client device 110. For example, the third-party system 130 stores one or more web pages and transmits the web pages to a client device 110 or to the online concierge system 102. The third-party system 130 may also communicate information to the online concierge system 102, such as advertisements, content, or information about an application provided by the third-party system 130.

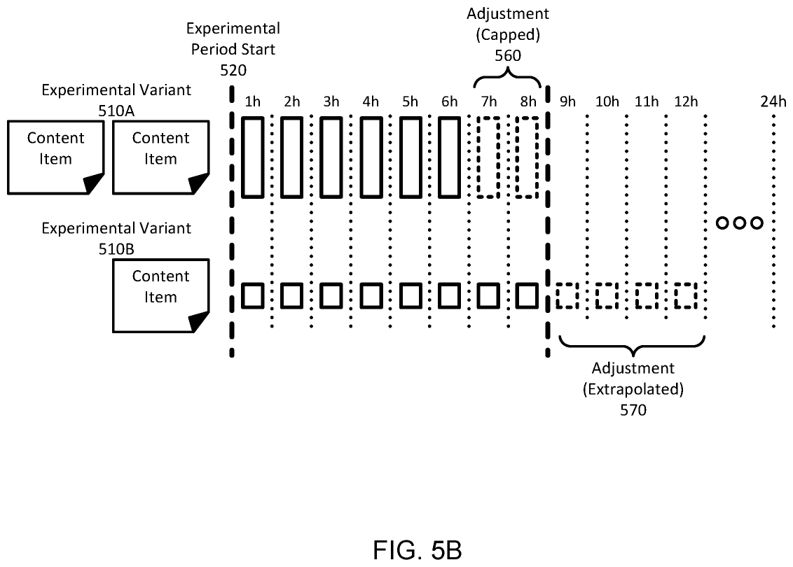

The online concierge system 102 includes one or more processors 142 configured to control operation of the online concierge system 102 by performing functions. In various embodiments, the online concierge system 102 includes a memory 144 comprising a non-transitory storage medium on which instructions are encoded. The memory 144 may have instructions encoded thereon corresponding to the modules further below in conjunction with FIG. 3 that, when executed by the processor 142, cause the processor to perform the functionality further described above in conjunction with FIGS. 2, 5A-B and 6. For example, the memory 144 has instructions encoded thereon that, when executed by the processor 142, cause the processor 142 to simulate experiments for content campaigns with different experimental variants and adjust results based on a fair value of each experimental variant. Additionally, the online concierge system 102 includes a communication interface configured to connect the online concierge system 102 to one or more networks, such as network 120, or to otherwise communicate with devices (e.g., client devices 110) connected to the one or more networks.

One or more of a client device 110, a third-party system 130, or the online concierge system 102 may be special-purpose computing devices configured to perform specific functions, as further described below in conjunction with FIGS. 2-6, and may include specific computing components such as processors, memories, communication interfaces, and/or the like.

### System Overview

FIG. 2 illustrates an environment 200 of an online platform, such as an online concierge system 102, according to one or more embodiments. The figures use like reference numerals to identify like elements. A letter after a reference numeral, such as “210a,” indicates that the text refers specifically to the element having that particular reference numeral. A reference numeral in the text without a following letter, such as “210,” refers to any or all of the elements in the figures bearing that reference numeral. For example, “210” in the text refers to reference numerals “210a” or “210b” in the figures.

The environment 200 includes an online concierge system 102. The online concierge system 102 is configured to receive orders from one or more users 204 (only one is shown for the sake of simplicity). An order specifies a list of goods (items or products) to be delivered to the user 204. The order also specifies the location to which the goods are to be delivered, and a time window during which the goods should be delivered. In some embodiments, the order specifies one or more retailers from which the selected items should be purchased. The user may use a customer mobile application (CMA) 206 to place the order; the CMA 206 is configured to communicate with the online concierge system 102.

The online concierge system 102 is configured to transmit orders received from users 204 to one or more shoppers 208. A shopper 208 may be a contractor, employee, other person (or entity), robot, or other autonomous device enabled to fulfill orders received by the online concierge system 102. The shopper 208 travels between a warehouse and a delivery location (e.g., the user's home or office). A shopper 208 may travel by car, truck, bicycle, scooter, foot, or other mode of transportation. In some embodiments, the delivery may be partially or fully automated, e.g., using a self-driving car. The environment 200 also includes three warehouses 210a, 210b, and 210c (only three are shown for the sake of simplicity; the environment could include hundreds of warehouses). The warehouses 210 may be physical retailers, such as grocery stores, discount stores, department stores, etc., or non-public warehouses storing items that can be collected and delivered to users. Each shopper 208 fulfills an order received from the online concierge system 102 at one or more warehouses 210, delivers the order to the user 204, or performs both fulfillment and delivery. In one embodiment, shoppers 208 make use of a shopper mobile application 212 which is configured to interact with the online concierge system 102.

FIG. 3 is a diagram of an online concierge system 102, according to one or more embodiments. In various embodiments, the online concierge system 102 may include different or additional modules than those described in conjunction with FIG. 3. Further, in some embodiments, the online concierge system 102 includes fewer modules than those described in conjunction with FIG. 3.

The online concierge system 102 includes an inventory management engine 302, which interacts with inventory systems associated with each warehouse 210. In one embodiment, the inventory management engine 302 requests and receives inventory information maintained by the warehouse 210. The inventory of each warehouse 210 is unique and may change over time. The inventory management engine 302 monitors changes in inventory for each participating warehouse 210. The inventory management engine 302 is also configured to store inventory records in an inventory database 304. The inventory database 304 may store information in separate records—one for each participating warehouse 210—or may consolidate or combine inventory information into a unified record. Inventory information includes attributes of items that include both qualitative and qualitative information about items, including size, color, weight, SKU, serial number, and so on. In one embodiment, the inventory database 304 also stores purchasing rules associated with each item, if they exist. For example, age-restricted items such as alcohol and tobacco are flagged accordingly in the inventory database 304. Additional inventory information useful for predicting the availability of items may also be stored in the inventory database 304. For example, for each item-warehouse combination (a particular item at a particular warehouse), the inventory database 304 may store a time that the item was last found, a time that the item was last not found (a shopper looked for the item but could not find it), the rate at which the item is found, and the popularity of the item.

For each item, the inventory database 304 identifies one or more attributes of the item and corresponding values for each attribute of an item. For example, the inventory database 304 includes an entry for each item offered by a warehouse 210, with an entry for an item including an item identifier that uniquely identifies the item. The entry includes different fields, with each field corresponding to an attribute of the item. A field of an entry includes a value for the attribute corresponding to the attribute for the field, allowing the inventory database 304 to maintain values of different categories for various items.

In various embodiments, the inventory management engine 302 maintains a taxonomy of items offered for purchase by one or more warehouses 210. For example, the inventory management engine 302 receives an item catalog from a warehouse 210 identifying items offered for purchase by the warehouse 210. From the item catalog, the inventory management engine 302 determines a taxonomy of items offered by the warehouse 210. Different levels in the taxonomy provide different levels of specificity about items included in the levels. In various embodiments, the taxonomy identifies a category and associates one or more specific items with the category. For example, a category identifies “milk,” and the taxonomy associates identifiers of different milk items (e.g., milk offered by different brands, milk having one or more different attributes, etc.), with the category. Thus, the taxonomy maintains associations between a category and specific items offered by the warehouse 210 matching the category. In some embodiments, different levels in the taxonomy identify items with differing levels of specificity based on any suitable attribute or combination of attributes of the items. For example, different levels of the taxonomy specify different combinations of attributes for items, so items in lower levels of the hierarchical taxonomy have a greater number of attributes, corresponding to greater specificity in a category, while items in higher levels of the hierarchical taxonomy have a fewer number of attributes, corresponding to less specificity in a category. In various embodiments, higher levels in the taxonomy include less detail about items, so greater numbers of items are included in higher levels (e.g., higher levels include a greater number of items satisfying a broader category). Similarly, lower levels in the taxonomy include greater detail about items, so fewer numbers of items are included in the lower levels (e.g., higher levels include a fewer number of items satisfying a more specific category). The taxonomy may be received from a warehouse 210 in various embodiments. In other embodiments, the inventory management engine 302 applies a trained classification module to an item catalog received from a warehouse 210 to include different items in levels of the taxonomy, so application of the trained classification model associates specific items with categories corresponding to levels within the taxonomy.

Inventory information provided by the inventory management engine 302 may supplement the training datasets 320. Inventory information provided by the inventory management engine 302 may not necessarily include information about the outcome of picking a delivery order associated with the item, whereas the data within the training datasets 320 is structured to include an outcome of picking a delivery order (e.g., if the item in an order was picked or not picked).

The online concierge system 102 also includes an order fulfillment engine 306 which is configured to synthesize and display an ordering interface to each user 204 (for example, via the customer mobile application 206). The order fulfillment engine 306 is also configured to access the inventory database 304 in order to determine which products are available at which warehouse 210. The order fulfillment engine 306 may supplement the product availability information from the inventory database 234 with an item availability predicted by the machine-learned item availability model 316. The order fulfillment engine 306 determines a sale price for each item ordered by a user 204. Prices set by the order fulfillment engine 306 may or may not be identical to in-store prices determined by retailers (which is the price that users 204 and shoppers 208 would pay at the retail warehouses). The order fulfillment engine 306 also facilitates transactions associated with each order. In one embodiment, the order fulfillment engine 306 charges a payment instrument associated with a user 204 when he/she places an order. The order fulfillment engine 306 may transmit payment information to an external payment gateway or payment processor. The order fulfillment engine 306 stores payment and transactional information associated with each order in a transaction records database 308.

In various embodiments, the order fulfillment engine 306 generates and transmits a search interface to a client device of a user for display via the customer mobile application 206. The order fulfillment engine 306 receives a query comprising one or more terms from a user and retrieves items satisfying the query, such as items having descriptive information matching at least a portion of the query. In various embodiments, the order fulfillment engine 306 leverages item embeddings for items to retrieve items based on a received query. For example, the order fulfillment engine 306 generates an embedding for a query and determines measures of similarity between the embedding for the query and item embeddings for various items included in the inventory database 304.

In some embodiments, the order fulfillment engine 306 also shares order details with warehouses 210. For example, after successful fulfillment of an order, the order fulfillment engine 306 may transmit a summary of the order to the appropriate warehouses 210. The summary may indicate the items purchased, the total value of the items, and in some cases, an identity of the shopper 208 and user 204 associated with the transaction. In one embodiment, the order fulfillment engine 306 pushes transaction and/or order details asynchronously to retailer systems. This may be accomplished via use of webhooks, which enable programmatic or system-driven transmission of information between web applications. In another embodiment, retailer systems may be configured to periodically poll the order fulfillment engine 306, which provides detail of all orders which have been processed since the last request.

The order fulfillment engine 306 may interact with a shopper management engine 310, which manages communication with and utilization of shoppers 208. In one embodiment, the shopper management engine 310 receives a new order from the order fulfillment engine 306. The shopper management engine 310 identifies the appropriate warehouse 210 to fulfill the order based on one or more parameters, such as a probability of item availability determined by a machine-learned item availability model 316, the contents of the order, the inventory of the warehouses, and the proximity to the delivery location. The shopper management engine e10 then identifies one or more appropriate shoppers 208 to fulfill the order based on one or more parameters, such as the shoppers' proximity to the appropriate warehouse 210 (and/or to the user 204), his/her familiarity level with that particular warehouse 210, and so on. Additionally, the shopper management engine 310 accesses a shopper database 312 which stores information describing each shopper 208, such as his/her name, gender, rating, previous shopping history, and so on.

As part of fulfilling an order, the order fulfillment engine 306 and/or shopper management engine 310 may access a customer database 314 which stores information describing each user. This information could include each user's name, address, gender, shopping preferences, favorite items, stored payment instruments, and so on.

The order fulfillment engine 306 may select and provide user interface elements and other components to be displayed to users and shoppers. As discussed above, users may interact with elements for selecting items to be included as part of an order. The order fulfillment engine 306 may select items to be presented to the user based on various factors and attributes, such as items searched for by a user, items related to items searched for by the user, items related to items in a user's order (e.g., a user's current cart), among other factors. In some instances, items may be presented to users based on a content campaign in which the relative prioritization of items may be affected by a presentation budget associated with the item.

As the display space on a user's device is limited, the presentation budget may be used as a mechanism to automatically allow the respective items to compete for selection in the display space based on the campaign. Stated another way, selection of one item typically prevents selection of another item, such that the prioritization of presenting one item thus naturally “competes” with prioritization of presenting another item. The items may thus be individual items that may be added to a user's order or may be other types of content or information that may be of value to present to the user and thus compete for limited space on the user's display. Thus, the items with respect to content presented in a content campaign may include items that may be added to an order and may also relate to other information or content that is not a direct presentation of an item offered as part of an order, such as other supplemental information or information that may be beneficial for a user. As examples, items for prioritization with the content campaigns may include informational items related to additional features or aspects of the online concierge system (e.g., information for assisting new users in navigating the system, suggestions for a user to try additional features or aspects, “how-to” informational tips for the online system, offers for a user to subscribe to additional optional features, etc.), suggested uses or complementary items for items in a user's cart (e.g., for food items, suggested recipes or food/drink pairings), and so forth.

The items may compete by offering a portion of the presentation budget (e.g., a bid) that may compete with portions of other budgets, such that the content campaign offering the highest value may reflect the highest prioritization for an item to be presented. For convenience, the portion offered by a campaign is referred to as a “bid.” However, the budget may not represent real currency and may represent other priorities competing for limited area on a user's display such as the examples above. In some circumstances, the content campaigns may include sponsored content, such that the bid represents a value from a promoter of a particular item for presenting that item to the user; in other circumstances, the items may represent the prioritization of items beneficial to effective operations of the system, warehouses, items of interest to users (e.g., suggested items to complement existing items), based on excess warehouse stock, etc.

The online concierge system 102 may thus select prioritized items based on the various content campaigns and presentation budgets. When a particular item is selected, a portion of the presentation budget is applied to the presentation. The online concierge system 102 may have different ways for presenting and/or selecting prioritized items. As discussed below with respect to the experimental analysis module 322 and campaign datasets 324, experiments may be performed to simulate the presentation of campaigns in different ways. An individual configuration for presenting prioritized items (e.g., the particular set of user interface elements used in presenting items, along with prioritized item selection frequency, selection process and so forth) is referred to with respect to an experimental variant. As prioritized content items are selected and presented to users during normal operation of the online concierge system 102, the presentation budget for the selected items is reduced based, in part, on the bid for the item; in some embodiments, the items may be selected based on a second-price auction. When the presentation budget is reached, the item is no longer prioritized for selection based on the content campaign. Different content campaigns may also be eligible to be provided to different users and orders based on various criteria, such as the warehouse fulfilling the order, items in the user's cart, the user's historical purchases, etc. As items are provided to users based on the presentation budget, data relating to the content campaigns may be stored in the campaign datasets 324, which may be used for further experimental analysis and simulation as discussed further below.

In various embodiments, the order fulfillment engine 306 determines whether to delay display of a received order to shoppers for fulfillment by a time interval. In response to determining to delay the received order by a time interval, the order fulfillment engine 306 evaluates orders received after the received order and during the time interval for inclusion in one or more batches that also include the received order. After the time interval, the order fulfillment engine 306 displays the order to one or more shoppers 208 via the shopper mobile application 212; if the order fulfillment engine 306 generated one or more batches including the received order and one or more orders received after the received order and during the time interval, the one or more batches are also displayed to one or more shoppers 208 via the shopper mobile application 212.

### Machine Learning Models

The online concierge system 102 further includes a machine-learned item availability model 316, a modeling engine 318, and training datasets 320. The modeling engine 318 uses the training datasets 320 to generate the machine-learned item availability model 316. The machine-learned item availability model 316 can learn from the training datasets 320, rather than follow only explicitly programmed instructions. The inventory management engine 302, order fulfillment engine 306, and/or shopper management engine 310 can use the machine-learned item availability model 316 to determine a probability that an item is available at a warehouse 210. The machine-learned item availability model 316 may be used to predict item availability for items being displayed to or selected by a user or included in received delivery orders. A single machine-learned item availability model 316 is used to predict the availability of any number of items.

The machine-learned item availability model 316 can be configured to receive as inputs information about an item, the warehouse for picking the item, and the time for picking the item. The machine-learned item availability model 316 may be adapted to receive any information that the modeling engine 318 identifies as indicators of item availability. At minimum, the machine-learned item availability model 316 receives information about an item-warehouse pair, such as an item in a delivery order and a warehouse at which the order could be fulfilled. Items stored in the inventory database 304 may be identified by item identifiers. As described above, various characteristics, some of which are specific to the warehouse (e.g., a time that the item was last found in the warehouse, a time that the item was last not found in the warehouse, the rate at which the item is found, the popularity of the item) may be stored for each item in the inventory database 304. Similarly, each warehouse may be identified by a warehouse identifier and stored in a warehouse database along with information about the warehouse. A particular item at a particular warehouse may be identified using an item identifier and a warehouse identifier. In other embodiments, the item identifier refers to a particular item at a particular warehouse, so that the same item at two different warehouses is associated with two different identifiers. For convenience, both of these options to identify an item at a warehouse are referred to herein as an “item-warehouse pair.” Based on the identifier(s), the online concierge system 102 can extract information about the item and/or warehouse from the inventory database 304 and/or warehouse database and provide this extracted information as inputs to the item availability model 316.

The machine-learned item availability model 316 contains a set of functions generated by the modeling engine 318 from the training datasets 320 that relate the item, warehouse, timing information, and/or any other relevant inputs, to the probability that the item is available at a warehouse. Thus, for a given item-warehouse pair, the machine-learned item availability model 316 outputs a probability that the item is available at the warehouse. The machine-learned item availability model 316 constructs the relationship between the input item-warehouse pair, timing, and/or any other inputs and the availability probability (also referred to as “availability”) that is generic enough to apply to any number of different item-warehouse pairs. In some embodiments, the probability output by the machine-learned item availability model 316 includes a confidence score. The confidence score may be the error or uncertainty score of the output availability probability and may be calculated using any standard statistical error measurement. In some examples, the confidence score is based in part on whether the item-warehouse pair availability prediction was accurate for previous delivery orders (e.g., if the item was predicted to be available at the warehouse and not found by the shopper or predicted to be unavailable but found by the shopper). In some examples, the confidence score is based in part on the age of the data for the item, e.g., if availability information has been received within the past hour, or the past day. The set of functions of the item availability model 316 may be updated and adapted following retraining with new training datasets 320. The machine-learned item availability model 316 may be any machine learning model, such as a neural network, boosted tree, gradient boosted tree or random forest model. In some examples, the machine-learned item availability model 316 is generated from the XGBoost algorithm.

The item probability generated by the machine-learned item availability model 316 may be used to determine instructions delivered to the user 204 and/or shopper 208, as described in further detail below.

The training datasets 320 relate a variety of different factors to known item availabilities from the outcomes of previous delivery orders (e.g., if an item was previously found or previously unavailable). The training datasets 320 include the items included in previous delivery orders, whether the items in the previous delivery orders were picked, warehouses associated with the previous delivery orders, and a variety of characteristics associated with each of the items (which may be obtained from the inventory database 304). Each piece of data in the training datasets 320 includes the outcome of a previous delivery order (e.g., if the item was picked or not). The item characteristics may be determined by the machine-learned item availability model 316 to be statistically significant factors predictive of the item's availability. For different items, the item characteristics that are predictors of availability may be different. For example, an item type factor might be the best predictor of availability for dairy items, whereas a time of day may be the best predictive factor of availability for vegetables. For each item, the machine-learned item availability model 316 may weight these factors differently, where the weights are a result of a “learning” or training process on the training datasets 320. The training datasets 320 are very large datasets taken across a wide cross section of warehouses, shoppers, items, warehouses, delivery orders, times, and item characteristics. The training datasets 320 are large enough to provide a mapping from an item in an order to a probability that the item is available at a warehouse. In addition to previous delivery orders, the training datasets 320 may be supplemented by inventory information provided by the inventory management engine 302. In some examples, the training datasets 320 are historic delivery order information used to train the machine-learned item availability model 316, whereas the inventory information stored in the inventory database 304 include factors input into the machine-learned item availability model 316 to determine an item availability for an item in a newly received delivery order. In some examples, the modeling engine 318 may evaluate the training datasets 320 to compare a single item's availability across multiple warehouses to determine if an item is chronically unavailable. This may indicate that an item is no longer manufactured. The modeling engine 318 may query a warehouse 210 through the inventory management engine 302 for updated item information on these identified items.

### Machine Learning Factors

The training datasets 320 include a time associated with previous delivery orders. In some embodiments, the training datasets 320 include a time of day at which each previous delivery order was placed. Time of day may impact item availability, since during high-volume shopping times, items may become unavailable that are otherwise regularly stocked by warehouses. In addition, availability may be affected by restocking schedules, e.g., if a warehouse mainly restocks at night, item availability at the warehouse will tend to decrease over the course of the day. Additionally, or alternatively, the training datasets 320 include a day of the week previous delivery orders were placed. The day of the week may impact item availability since popular shopping days may have reduced inventory of items or restocking shipments may be received on particular days. In some embodiments, training datasets 320 include a time interval since an item was previously picked in a previous delivery order. If an item has recently been picked at a warehouse, this may increase the probability that it is still available. If there has been a long time interval since an item has been picked, this may indicate that the probability that it is available for subsequent orders is low or uncertain. In some embodiments, training datasets 320 include a time interval since an item was not found in a previous delivery order. If there has been a short time interval since an item was not found, this may indicate that there is a low probability that the item is available in subsequent delivery orders. And conversely, if there has been a long time interval since an item was not found, this may indicate that the item may have been restocked and is available for subsequent delivery orders. In some examples, training datasets 320 may also include a rate at which an item is typically found by a shopper at a warehouse, a number of days since inventory information about the item was last received from the inventory management engine 302, a number of times an item was not found in a previous week, or any number of additional rate or time information. The relationships between this time information and item availability are determined by the modeling engine 318 training a machine learning model with the training datasets 320, producing the machine-learned item availability model 316.

The training datasets 320 include item characteristics. In some examples, the item characteristics include a department associated with the item. For example, if the item is yogurt, it is associated with the dairy department. The department may be the bakery, beverage, nonfood, and pharmacy, produce and floral, deli, prepared foods, meat, seafood, dairy, the meat department, or dairy department, or any other categorization of items used by the warehouse. The department associated with an item may affect item availability, since different departments have different item turnover rates and inventory levels. In some examples, the item characteristics include an aisle of the warehouse associated with the item. The aisle of the warehouse may affect item availability since different aisles of a warehouse may be more frequently re-stocked than others. Additionally, or alternatively, the item characteristics include an item popularity score. The item popularity score for an item may be proportional to the number of delivery orders received that include the item. An alternative or additional item popularity score may be provided by a retailer through the inventory management engine 302. In some examples, the item characteristics include a product type associated with the item. For example, if the item is a particular brand of a product, then the product type will be a generic description of the product type, such as “milk” or “eggs.” The product type may affect the item availability, since certain product types may have a higher turnover and re-stocking rate than others or may have larger inventories in the warehouses. In some examples, the item characteristics may include a number of times a shopper was instructed to keep looking for the item after he or she was initially unable to find the item, a total number of delivery orders received for the item, whether or not the product is organic, vegan, gluten free, or any other characteristics associated with an item. The relationships between item characteristics and item availability are determined by the modeling engine 318 training a machine learning model with the training datasets 320, producing the machine-learned item availability model 316.

The training datasets 320 may include additional item characteristics that affect the item availability and can therefore be used to build the machine-learned item availability model 316 relating the delivery order for an item to its predicted availability. The training datasets 320 may be periodically updated with recent previous delivery orders. The training datasets 320 may be updated with item availability information provided directly from shoppers 208. Following updating of the training datasets 320, a modeling engine 318 may retrain a model with the updated training datasets 320 and produce a new machine-learned item availability model 316.

### Experimental Simulation

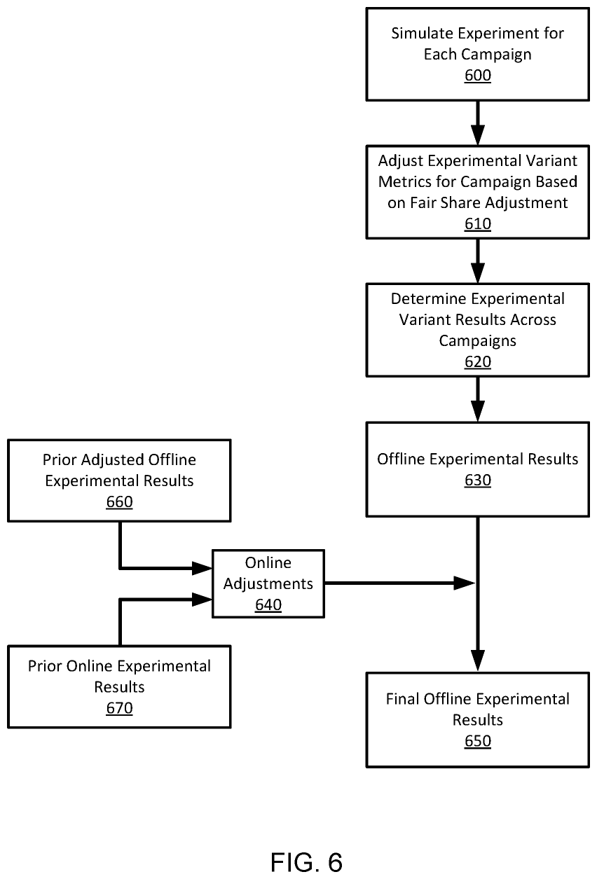

To evaluate modifications to the user interfaces and presentation of the prioritized item campaigns, experiments may be performed to evaluate the effect of the modified interfaces and selection process by the experimental analysis module 322. The experimental analysis module 322 may retrieve information about content campaigns as provided to users during operation of the online concierge system 102 from the campaign datasets 324 and evaluate different conditions for selection and presentation of content, particularly of prioritized content campaigns. As an overview, the experimental analysis module 322, in one embodiment, performs an experiment that includes a plurality of experimental variants, typically including at least one “control” variant and one “experimental” variant. Each variant describes a particular method for selecting and presenting content, including processing prioritized content campaigns, over an experimental time period and evaluates metrics for the campaigns at each of the variants. The experimental analysis module 322 may perform the experiments with a joint presentation budget for the variants, such that presentation of an item for a content campaign by any variant may reduce the budget. The experiments may include performing the experiments on live users accessing the online system (i.e., an “online” experiment) as well as simulation of such experiments, which may be based on an online experiment or simulated based on other information). To account for the differences in budget use by the different variants, the difference in budget use may be compared with a “fair value” of the budget used by each variant to adjust metrics for each campaign variant and account for differences between different budget usage by the variants. Further details of the experiments and these adjustments are discussed with respect to FIGS. 5A, 5B, and 6.

### Customer Mobile Application

FIG. 4A is a diagram of a customer mobile application (CMA) 206, according to one or more embodiments. The CMA 206 includes an ordering interface 402, which provides an interactive interface with which the user 204 can browse through and select products and place an order. The CMA 206 also includes a system communication interface 404 which, among other functions, receives inventory information from the online concierge system 102 and transmits order information to the system online concierge system 102. The CMA 206 also includes a preferences management interface 406 which allows the user 204 to manage basic information associated with his/her account, such as his/her home address and payment instruments. The preferences management interface 406 may also allow the user to manage other details such as his/her favorite or preferred warehouses 210, preferred delivery times, special instructions for delivery, and so on.

### Shopper Mobile Application

FIG. 4B is a diagram of the shopper mobile application (SMA) 212, according to one or more embodiments. The SMA 212 includes a barcode scanning module 420 which allows a shopper 208 to scan an item at a warehouse 210 (such as a can of soup on the shelf at a grocery store). The barcode scanning module 420 may also include an interface which allows the shopper 208 to manually enter information describing an item (such as its serial number, stock-keeping unit (SKU), quantity and/or weight) if a barcode is not available to be scanned. SMA 212 also includes a basket manager 422 which maintains a running record of items collected by the shopper 208 for purchase at a warehouse 210. This running record of items is commonly known as a “basket.” In one embodiment, the barcode scanning module 420 transmits information describing each item (such as its cost, quantity, weight, etc.) to the basket manager 422, which updates its basket accordingly. The SMA 212 also includes a system communication interface 424 which interacts with the online shopping concierge system 102. For example, the system communication interface 424 receives an order from the online concierge system 102 and transmits the contents of a basket of items to the online concierge system 102. The SMA 212 also includes an image encoder 426 which encodes the contents of a basket into an image. For example, the image encoder 426 may encode a basket of goods (with an identification of each item) into a QR code which can then be scanned by an employee of the warehouse 210 at check-out.

Experimental Simulation with Fairness Adjustment

FIGS. 5A-B illustrate experimental variants for a content campaign with a fairness adjustment, according to one or more embodiments. FIGS. 5A-5B shows an example in which two experimental variants 510A-B modify the frequency that prioritized content items are selected and presented to users. For example, the user interface flow for users to select items for an order may include two positions for selecting prioritized content items rather than one position. The experimental variants 510A and 510B may represent a control (e.g., the current or typical process for selecting or displaying content) and a treatment condition (e.g., a proposed modification). While two experimental variants 510A-B are shown in FIG. 5A, multiple experimental variants may be used in different embodiments.

Each experiment may be run to determine results for one or more experimental periods that may correspond to an available campaign budget. In practice, many presentation budgets may be established for a number of days, such as a calendar month, with a maximum for each day. As such, in some embodiments, the experiment may be configured to determine results for one day of a presentation budget for a campaign, such that an experimental period is one day having a presentation budget determined by a content campaign's daily maximum.

In some embodiments, the results may be based on an online experiment in which users may receive content according to the different experimental variants. As users access the online system, each user may be assigned to one of the experimental variants. The users assigned to variants (e.g., to take part in the experiment) may be a subset of users accessing the online system selected by appropriate means, such as randomly or those meeting selection criteria. As users are assigned to an experimental variant, each experimental variant selects interfaces and content for the user according to the configuration of the experimental variant, which may include selection of content from a set of one or more content campaigns. The set of content campaigns may be the same across the experimental variants, such that selection of a particular content campaign by one variant may use a portion of a joint budget for the content campaign. As such, the online experiment may determine experimental results for the experimental variants with respect to the set of campaigns for an online experimental period (e.g., 1 hour, 3 hours, 6 hours, etc.). The online experiment may end when the joint budget for a content campaign (e.g., any campaign in the set of content campaigns) is used, or when the online experimental period ends. In addition to the online experiment, experimental results may also be simulated to evaluate results for a different (e.g., longer) time period, results for additional campaigns, and to adjust the results to account for the different spending rates for the content campaigns for each of the experimental variants. The results of the online experiment may be stored with the campaign datasets 324.

To perform the simulation for a content campaign, information about the content campaign is retrieved from the campaign datasets 324 and used to simulate the effect of applying each experimental variant across the experimental period (which may be longer than the online experiment). In some embodiments, the simulation may be a “replay” of the online experiment, such that the information from the online experiment is used to determine the results of the campaign for the experimental variants. The simulated results and experimental period in this embodiment may be the same as the online period, or the results of the online experiment may be extrapolated to the desired length of the simulated experiment. The results may then be adjusted to account for the different budget use (e.g., spending rates) of the different experimental variants as discussed below.

In addition or alternatively, the simulation may also simulate the results for the campaign based on other factors, such as prior campaigns, presentation frequency differences between the variants, etc. The particular details of the simulation will vary in different embodiments and according to the particular experimental variants. The simulation may begin at an experimental period start 520 and continue to an experimental period end 540 (e.g., the end of a 24-hour day). The simulation may evaluate the experimental variants sequentially for intervals of the time period (e.g., every hour, quarter hour, ten minutes, etc.). The size of an interval may be based on the type and granularity of data stored in the campaign datasets 324.

As noted above, the campaign datasets 324 may store information from content campaigns as previously run by the online concierge system 102 (and may include, e.g., performance of content campaigns in an online experiment including the experimental variants) to be used for simulating the performance of the experiments in different experimental variants. The campaign datasets 324 may thus include different information in different embodiments and may be configured according to the particular type of prioritized content selection processes or simulation architectures. For a particular campaign, the experimental period is evaluated by intervals beginning at the experimental period start 520. At each interval, the experimental variants 510 are each simulated with the campaign data to determine the budget use of each variant, which may use a portion of the available campaign budget 550. The available campaign budget 550 may be jointly used by the experimental variants, such that the budget use rates of each variant may jointly reduce the simulated available campaign budget 550.

At each interval, the budget used by each variant reduces the available campaign budget. The available campaign budget 550 is tracked so that when the available campaign budget reaches zero, the interval at which the budget is exhausted in the experimental time period 530 is determined. By jointly reducing the campaign budget, the simulation may approximate the results of an experiment in which the campaign budget is not split across the variants in an online setting. As such, this approach allows the experiment to simulate online experiments in which the budget for a content campaign is jointly used to synchronize campaign budgets. The simulation for the campaign may end at the interval at which the budget is exhausted 530 is determined (based e.g., on the available campaign budget 550 reaching zero). Rather than decreasing an available budget, the used budget may also be tracked by accumulating the budget used by each variant and comparing the used budget across variants to a total campaign budget, and determining to end the simulation when the used budget reaches or exceeds the campaign budget for the experimental period.

At each interval, the simulation may evaluate information about the content campaign and users accessing the online concierge system during that interval to determine the likely outcomes for the content campaign in that interval. In general, the results of the simulation with respect to a content campaign may describe the number of times an item is selected for presentation based on the prioritization campaign and the conditions in which the campaign competed for presentation and the circumstances in which the campaign was or was not presented. For example, the simulation may evaluate how often there are opportunities to present content to users matching circumstances of interest to the campaign, a holdout frequency of the campaign (e.g., a frequency that the campaign did not participate in eligible opportunities), the bid offered by the campaign (e.g., when the bid may be variable), whether the campaign “won” the presentation opportunity, the competing bids by other campaigns (e.g., the highest competing bid), the price paid when the campaign won the presentation, and so forth.

The particular way in which the simulation is evaluated may depend on the particular implementation and granularity of simulation along with the type of data for campaigns and opportunities in an interval (e.g., based on the data from users accessing the online concierge system and related live campaigns stored in campaign datasets 324). The simulation of an interval may be a function of the users accessing the online concierge system in an interval, characteristics of the content campaign, and the campaign selection process. For example, for the users that are simulated to access the online concierge system in a given interval, the experimental variant 510 may determine the number of the opportunities for presenting prioritized content for each user and the outcomes of the opportunities for the campaign. This may be based, for example, on the user interfaces and sequence thereof for a particular experimental variant 510. In the example of FIG. 5A, experimental variant 510A includes two prioritized content item opportunities for each prioritized content item opportunity of the experimental variant 510B. The experimental variants 510 may vary different aspects of the prioritized item selection process, such as a holdout frequency (or an algorithm for modifying the holdout frequency), the selection process or value used when an item is selected (e.g., including additional factors in addition to the bid of the prioritization campaign or using a different selection process such as a different auction type), that may vary according to the particulars of the experimental variants 510. In some embodiments, the campaign datasets 324 may include data for each campaign that may be evaluated at each interval for each variant, such as the number of users and/or opportunities for that campaign, the bid and/or budget for the campaign during a particular interval, the frequency that the campaign won an auction, the prioritization value used when the campaign won a presentation opportunity (e.g., an auction), the prioritization value used when the campaign lost a presentation opportunity, and so forth. As such, generally, the simulation for an experimental variant may be based on the data of users and campaigns during operation of the online concierge system 102 and simulates the effects of the experimental variant on presentation frequency and results.

For each experimental variant 510 of the campaign, metrics may be determined to describe the aspects of the experimental variant. The metrics may be determined for the variant at each interval and accumulated. Alternatively (or, for some metrics, in addition), some metrics may be determined after the budget is exhausted for the period 530 and the experimental period reaches the experimental period end 540. The metrics may vary in different embodiments and according to the particulars of the simulation. The various metrics for the experimental variants may be determined based on individual campaigns, and in some embodiments may include metrics determined across a plurality of evaluated campaigns. The metrics may include metrics related to performance of the online concierge system in providing items (e.g., processor or memory costs), metrics relating to the user experience (e.g., the number of interfaces provided to users or time to navigate interfaces for the order generated for a user), and metrics describing the presentation of prioritized items and content campaigns. The metrics relating to presentation of prioritized items may include a total budget use and/or a rate of budget use, a holdout frequency, a frequency that the particular campaign had the highest bid for presentation, average difference between the campaign's bid and other bids for the user, average order value or expected value of item prioritization for winning item presentation, and so forth.

However, as the budget use rate may differ significantly across experimental variants and the available budget for a campaign for a given period may be limited, the experimental metrics determined based on spending that exhausts a presentation budget before the experimental period end 540 may not mean that the metrics reflect the “true” effects of the campaigns compared across the variants. In addition, as discussed further below, when the budget exhausts for a campaign, in practice, items from other campaigns (with other bids and campaign budgets) may then be evaluated for the intervals after the budget is exhausted, such that additional intervals may provide different metrics. As such, to correct for the different budget use rates of the variants 510 for a particular campaign, a fair value for each experimental variant may be determined and used to adjust the metrics to simulate the budget for the campaign to be “fairly” split between the experimental variants. This adjustment permits the experiment to be simulated with a joint budget for the campaign and then adjusted based on the fair value, simplifying the experimental process and reducing the total overhead for the experiments as the variants may be jointly evaluated for the same number of intervals until the (joint) budget is exhausted.

FIG. 5B shows an example adjustment to modify metrics for an experimental variant to account for the different budget use for each variant. In the example of FIGS. 5A-5B, the experimental variant 510A includes additional opportunities to present prioritized content items, and thus may use a campaign budget relatively faster than the experimental variant 510B. When metrics are compared between the two experimental variants, it may thus appear that the experimental variant 510A may significantly increase a metric related to the total value of budget used for the prioritized content items. However, this may be misleading in that the experimental variant 510B would also be expected to use the complete budget within the experimental period. As such, one or more of the metrics for an experimental variant may be modified by an adjustment to determine a set of adjusted metrics.

To determine the adjustment, a “fair value” (or “fair share”) of the budget may be determined for the experimental variant that reflects a portion of the budget based on the number of experimental variants 510 and/or the split of users that might be allocated to each experimental variant in a live experiment. For example, in some embodiments, the users may be evenly-split across the experimental variants, such that the “fair value” is an even split among the experimental variants. For two experimental variants in this case, the “fair value” may be an evenly-split (i.e., one half) of the presentation budget. The fair value may then be compared with the simulated budget used for the experimental variants 510 to determine an adjustment to increase or decrease the metrics for the experimental variant.

When the experimental variant used more budget than its fair value, the experimental variant may be adjusted to “cap” the contribution of the experimental intervals to the intervals before the experimental variant reached the fair value of the variant. In the example of FIG. 5B, the experimental variant 510A had a higher budget use rate, and thus the adjustment 560 reduces the metrics for that variant to the capped interval. In some embodiments, the adjusted metrics may be based on a portion of the fair value relative to the portion of the budget, and in others, the metrics for the prior intervals may be accumulated to the point at which the campaign budget for the variant exceeds its fair value.

When the experimental variant uses less than its fair value, the metrics for the experimental variant are modified to extrapolate from when the simulated campaign budget was reached. For example, the experimental variant 510B was stopped at the interval corresponding to 8 hours as the jointly available campaign budget was used. However, given the relatively lower spending rate of the experimental variant 510B relative to fair value, had the budgets been “fairly” allocated to the experimental variant 510B, it would have continued to participate in opportunities to present prioritized content. As such, the adjustment 570 for an experimental variant 510 that is below its fair share may extrapolate metrics beyond the interval in the experimental period at which the budget was exhausted. In some embodiments, the extrapolated intervals may be configured not to exceed the experimental period. By simulating metrics for campaigns with a joint presentation budget, the experimental variants may more efficiently be simulated offline (e.g., with lower processing and/or memory costs). To correct the potential errors that may occur due to the different rates at which budgets are used, the adjustment based on a fair budget allocation allows the resulting metrics to be adjusted and address the possible distortion of the joint budget use.

FIG. 6 is a flowchart of a method for simulating experiments with content campaigns, according to one or more embodiments. In various embodiments, the method includes different or additional steps than those described in conjunction with FIG. 6. Further, in some embodiments, the steps of the method may be performed in different orders than the order described in conjunction with FIG. 6. The method described in conjunction with FIG. 6 may be carried out by the online concierge system 102 in various embodiments, such as by the experimental analysis module 322, while in other embodiments, the steps of the method are performed by any online system capable of retrieving items.

In addition to the per-campaign adjustments for fairness as discussed with respect to FIGS. 5A-B, the results for the experiments may be further refined by combining the metrics across multiple campaigns and may be further adjusted to correct for campaign-campaign effects and joint campaign budget effects. As discussed with respect to FIGS. 5A-B, an experiment with a plurality of experimental variants may be simulated 600 for a historical campaign across an experimental period to determine a set of metrics for the campaign. The metrics for each experimental variant of the campaign may then be adjusted 610 based on a fair share of the budget relative to the portion of the budget for the campaign used by the experimental variant.

The experimental variants may be simulated for a plurality of content campaigns, each of which may have its metrics determined and adjusted by the respective fair share, such that the results for each experimental variant may be determined 620 across the plurality of campaigns. The adjusted metrics may then be combined to determine the overall offline experimental results 630 for each variant based on the offline experiments and fairness adjustment.

In some embodiments, these results may be further modified to account for additional potential distortions that may be based on the simulation on historical data (e.g., as an “offline” simulation). The offline experimental results 630 may thus be further modified by a set of one or more online adjustments 640 to determine final offline experimental results 650.

The online adjustments 640 may be determined based on a set of prior adjusted offline experimental results 660 and a set of corresponding prior online experiment results 670. That is, the difference between prior experimental results offline compared to online experiments may be used to determine adjustments (e.g., factors) that may correct for differences between the offline experimental results 630 and the results that may be obtained were the same experimental variants performed online. In some examples, as different variants may affect the selection of content differently, in one embodiment, characteristics of the experimental variants may be used to select comparable experiments for the prior online experimental results 670 to determine prior experimental results that are expected to deviate in similar ways to the current experiment and its variants.

As one example, the online adjustments 640 may include an adjustment to account for campaign-campaign effects. In some embodiments, the offline experimental results may be performed for each campaign as discussed above while treating other competing campaigns as static factors (e.g., the bids used by other campaigns to compete with a particular campaign). In practice, however, the experimental variants may affect all campaigns simultaneously when presenting the content items to users, causing the behavior of campaigns to affect other campaigns. To determine the effect of these effects, the same experimental variants may be performed in offline experiments and stored as prior adjusted offline experimental results 660 and as prior online experimental results 670. Comparison between the two may determine an online adjustment 640 that may be generalizable to other experiments, such that it may be applied to correct the offline experimental results 630. This may estimate and account for campaign-campaign effects without requiring the current experiment to be re-run in an online environment.

As another example embodiment, the online adjustments 640 may include an adjustment in which the campaign budget is split for each experimental variant. This adjustment may account for the potential differences of a joint campaign budget for the experimental variants (as may be performed for the offline simulations as discussed above) and the “separate” campaign budget that may be expected if an experimental variant is adopted as the operating approach of the online concierge system. To do so, independent sets of content campaigns with separate presentation budgets may be established for each experimental variation in an online experiment. When the content is presented for an experimental variant, the budget for the content campaign specific to that variant may be used, allowing the content campaign of each variant to exhaust respective budgets at different times. By comparing these results to the results of a joint campaign (either online or offline), an adjustment may be determined that further accounts for split budget experiments relative to the joint budget experiments. These experiments may also be comparatively costly to perform as each variant provides a separate pipeline and campaign budget, so the adjustment may be determined based on one or more prior experiments and applied to adjust offline experimental results 630 of future experiments.

Finally, additional statistical measures may be performed on the experimental results, for example to determine a mean, median, and other measures of the metrics for the experimental variants. In one example, a confidence interval for the metrics may be determined based on a resampling, such as jackknife resampling, of the campaigns for an experimental variant to evaluate the significance of the contribution of individual campaign data to the metrics for the experimental variant metrics as a whole.

Together, these approaches provide a way for effective simulation of a large number of experiments having different experimental variations without the drawbacks of splitting a campaign budget in an online production environment. In addition, the results of the experimental variation in some embodiments may be automatically applied to adjust the configuration of the online system. For example, based on the experimental results and the confidence intervals thereof, one of the experimental variants may automatically be selected for presentation of content for further users, e.g., as the standard or “control” for selecting and presenting content to users accessing the system.

### Additional Considerations

The foregoing description of the embodiments of the invention has been presented for the purpose of illustration; it is not intended to be exhaustive or to limit the invention to the precise forms disclosed. Many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a computing device selectively activated or reconfigured by a computer program stored in the computer. Such a computer program may be stored in a tangible computer readable storage medium, which includes any type of tangible media suitable for storing electronic instructions and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising, at a computer system comprising a processor and a computer-readable medium:
identifying a plurality of content campaigns for experiments of a plurality of experimental variants, each content campaign having an associated presentation budget;
for each content campaign in the plurality of content campaigns:
determining a set of campaign metrics for the content campaign for each of the plurality of experimental variants by presentation of the content campaign with the plurality of experimental variants during an experimental time period until the associated presentation budget for the content campaign is reached, and
determining a set of adjusted campaign metrics for the content campaign for each of the experimental variants based on the set of campaign metrics and an adjustment based on a portion of the presentation budget used by the experimental variant relative to a fair value of the experimental variant;
determining a set of simulated experimental results for each experimental variant of the plurality of experimental variants by combining the set of adjusted campaign metrics associated with the experimental variant for each of the plurality of content campaigns; and
based on the set of simulated experimental results, selecting an experimental variant for presentation of content.

2. The method of claim 1, wherein determining the set of simulated experimental results includes applying an online adjustment determined from another experiment performed online.

3. The method of claim 2, further comprising determining the online adjustment based on a comparison of another set of simulated experimental results with a set of live experimental results.

4. The method of claim 3, wherein the set of live experimental results are determined based on a split presentation budget between the experimental variants.

5. The method of claim 3, wherein the live experimental results are determined based on a joint presentation budget between the experimental variants.

6. The method of claim 1, wherein presentation of the content campaign with the plurality of experimental variants occurs at different presentation frequencies.

7. The method of claim 1, wherein presentation of the content campaign with the plurality of experimental variants results in different spend rates of the presentation budget.

8. The method of claim 1, wherein the plurality of experimental variants includes a control and one or more experimental variations.

9. The method of claim 1, wherein determining the set of simulated experimental results includes determining a confidence interval based on jackknife resampling of the content campaigns.

10. A computer program product comprising a non-transitory computer readable storage medium having instructions encoded thereon that, when executed by a processor, cause the processor to:
identify a plurality of content campaigns for simulated experiments of a plurality of experimental variants, each content campaign having an associated presentation budget;
for each content campaign in the plurality of content campaigns:
determine a set of campaign metrics for the content campaign for each of the plurality of experimental variants by presentation of the content campaign with the plurality of experimental variants during an experimental time period until the associated presentation budget for the content campaign is reached, and
determine a set of adjusted campaign metrics for the content campaign for each of the experimental variants based on the set of campaign metrics and an adjustment based on a portion of the presentation budget used by the experimental variant relative to a fair value of the experimental variant;
determine a set of simulated experimental results for each experimental variant of the plurality of experimental variants by combining the set of adjusted campaign metrics associated with the experimental variant for each of the plurality of content campaigns; and
based on the set of simulated experimental results, selecting an experimental variant for presentation of content.

11. The computer program product of claim 10, wherein determining the set of simulated experimental includes applying an online adjustment determined from another experiment performed online.

12. The computer program product of claim 11, further comprising determining the online adjustment based on a comparison of another set of simulated experimental results with a set of live experimental results.

13. The computer program product of claim 12, wherein the set of live experimental results are determined based on a split presentation budget between the experimental variants.

14. The computer program product of claim 12, wherein the live experimental results are determined based on a joint presentation budget between the experimental variants.

15. The computer program product of claim 10, wherein presentation of the content campaign with the plurality of experimental variants occurs at different presentation frequencies.

16. The computer program product of claim 10, wherein presentation of the content campaign with the plurality of experimental variants results in different spend rates of the presentation budget.

17. The computer program product of claim 10, wherein the plurality of experimental variants includes a control and one or more experimental variations.

18. The computer program product of claim 10, wherein determining the set of simulated experimental results includes determining a confidence interval based on jackknife resampling of the content campaigns.

19. A computer system comprising:
a processor; and
a non-transitory computer readable storage medium storing instructions that, when executed by the processor, cause the computer system to perform actions comprising:
identifying a plurality of content campaigns for experiments of a plurality of experimental variants, each content campaign having an associated presentation budget;
for each content campaign in the plurality of content campaigns:
determining a set of campaign metrics for the content campaign for each of the plurality of experimental variants by presentation of the content campaign with the plurality of experimental variants during an experimental time period until the associated presentation budget for the content campaign is reached, and
determining a set of adjusted campaign metrics for the content campaign for each of the experimental variants based on the set of campaign metrics and an adjustment based on a portion of the presentation budget used by the experimental variant relative to a fair value of the experimental variant;
determining a set of simulated experimental results for each experimental variant of the plurality of experimental variants by combining the set of adjusted campaign metrics associated with the experimental variant for each of the plurality of content campaigns and
based on the set of simulated experimental results, selecting an experimental variant for presentation of content.

20. The system of claim 19, wherein determining the set of simulated experimental results includes applying an online adjustment determined from another experiment performed online.
